(19) United States
(12) Patent Application Publication
(10) Pub. No.: US 2013/0151620 A1
(43) Pub. Date: Jun. 13, 2013

(54) METHOD AND SYSTEM FOR CONTROLLING DISPLAYS IN PEER-TO-PEER CONFERENCING SYSTEMS

(71) Applicants: Hrishikesh DESHPANDE, Pacifica, CA (US); Erika CHUANG, Los Gatos, CA (US); Bram THIJSSEN, Maastricht (NL); Marcellus CHEN, Fremont, CA (US); Milton CHEN, San Jose, CA (US)

(72) Inventors: Hrishikesh DESHPANDE, Pacifica, CA (US); Erika CHUANG, Los Gatos, CA (US); Bram THIJSSEN, Maastricht (NL); Marcellus CHEN, Fremont, CA (US); Milton CHEN, San Jose, CA (US)

(21) Appl. No.: 13/762,215

(22) Filed: Feb. 7, 2013

Related U.S. Application Data
(62) Division of application No. 12/433,724, filed on Apr. 30, 2009.

(51) Int. Cl. H04L 29/06

(52) U.S. Cl. CPC H04L 65/403
USPC 709/204

(57) ABSTRACT

A peer-to-peer conferencing system provides participants in a conferencing session information regarding the display capabilities of other participants so that the local displays of all the participants can appropriately notify their respective participants of differences in the display capability of a presenter during the conferencing session. The conferencing system further ensures that notifications are received at each of the participants so that each participant is able to synchronize its local display with the pace of a conferencing session.

### CROSS-REFERENCE TO RELATED APPLICATION

This application is a divisional of U.S. patent application Ser. No. 12/433,724, filed on Apr. 30, 2009 and is hereby incorporated by reference.

### BACKGROUND OF THE INVENTION

1. Field of the Invention

The present invention relates generally to peer-to-peer conferencing technologies, and more particularly, to controlling displays in peer-to-peer conferencing systems.

2. Description of the Related Art

Current web conferencing systems utilize hub-and-spoke based architectures in which distribution of data streams are managed by a central server. For example, a presenter for a web conferencing session establishes a connection with a central server that enables an image of the presenter's desktop to be transmitted to and continuously updated at the central server during the web conferencing session. Other participants also establish connections with the central server so that it is able to transmit the presenter's desktop image to the other participants.

In such a hub-and-spoke based architecture, the central server is able to effectively manage data traffic issues and, for example, control the pace of a conference. For example, in a web conferencing session, the central server can ensure that participants with the slowest established connections successfully receive the most current web conferencing images and data before transmitting additional images and data to the rest of the participants. However, providing this assurance means that the central server also becomes as a bottleneck through which all data traffic must run.

In order to reduce its bottleneck effect, the central server sometimes adopts a “lowest common denominator” approach when transmitting presenter images and data to participants. For example, rather than transmitting each participant a customized image of a presenter's desktop that leverages the local display capabilities of the participant's display terminal (e.g., having different resolutions, widths, etc.), a central server simply transmits one “lowest common denominator” image (e.g., low resolution, small width, etc.) of the presenter's desktop that is capable of being displayed on all participants' displays. Such a method, however, can create confusion among participants, particularly if the presenter has better display capabilities (e.g., wider screen, better resolution, etc.) than a “lowest common denominator” display. In such a situation, the presenter may refer to items on his display during the web conferencing session without realizing that other participants cannot view such items.

Peer-to-peer (P2P) web conferencing systems obviate the bottleneck created by a central server by establishing direct connections between and among each participant in a web conferencing session. A “lowest common denominator” approach to data transmission can be avoided in a peer-to-peer web conferencing system because each participant can be responsible for optimizing its own local conferencing session environment without needing to consider the capabilities of other participants. However, while peer-to-peer web conferencing systems eliminate bottleneck issues and problems with the “lowest common denominator” approach, they also lose the centralized management function that a central server provides, for example, managing data traffic issues to control the pace of conferences.

### SUMMARY OF THE INVENTION

One or more embodiments of the invention provide a method and a system for generating graphical user interfaces displayed on computer systems of participants in a peer-to-peer conferencing system. Embodiments of the invention leverage the ability of each participant's computer system to receive information from each of the other participants' computer systems and customize its own display according to its own display capabilities. Embodiments of the invention also ensure that proper notifications are received at each participant computer system so that each participant computer system is able to synchronize its local display of a conferencing session with the pace of the conferencing session.

According to one embodiment of the present invention, a method for providing display notifications in a peer-to-peer conferencing session among a plurality of participant computer systems is disclosed herein. The method comprises establishing a direct network connection with each of the participant computer systems, receiving information relating to display capabilities of each of the participant computer systems through each established direct network connection, determining a difference in capabilities between the received information and a local display of a local computer system, and presenting a display notification relating to the determined difference on the local display.

### BRIEF DESCRIPTION OF THE DRAWINGS

So that the manner in which the above recited feature of the present invention can be understood in more detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a peer-to-peer web conferencing topology in which embodiments present invention may be utilized.

FIGS. 2A-2B depict web conferencing displays of a presenter and a participant during a web conferencing session that is carried out according to one embodiment of the present invention.

FIG. 3 is a flow diagram of steps taken between a presenter and a participant in a peer-to-peer web conferencing session that is carried out according to one embodiment of the present invention.

FIG. 4 is a sample display of a graphical notification displayed by a client application of a peer-to-peer web conferencing system if a participant is interacting with the display of the web conference.

FIG. 5 is a flow diagram of steps taken by a participant in a peer-to-peer web conferencing session that is carried out according to one embodiment of the present invention

FIG. 6 is a flow diagram of steps taken by a client application of a presenter in a peer-to-peer web conferencing session that is carried out according to one embodiment of the present invention.

### DETAILED DESCRIPTION

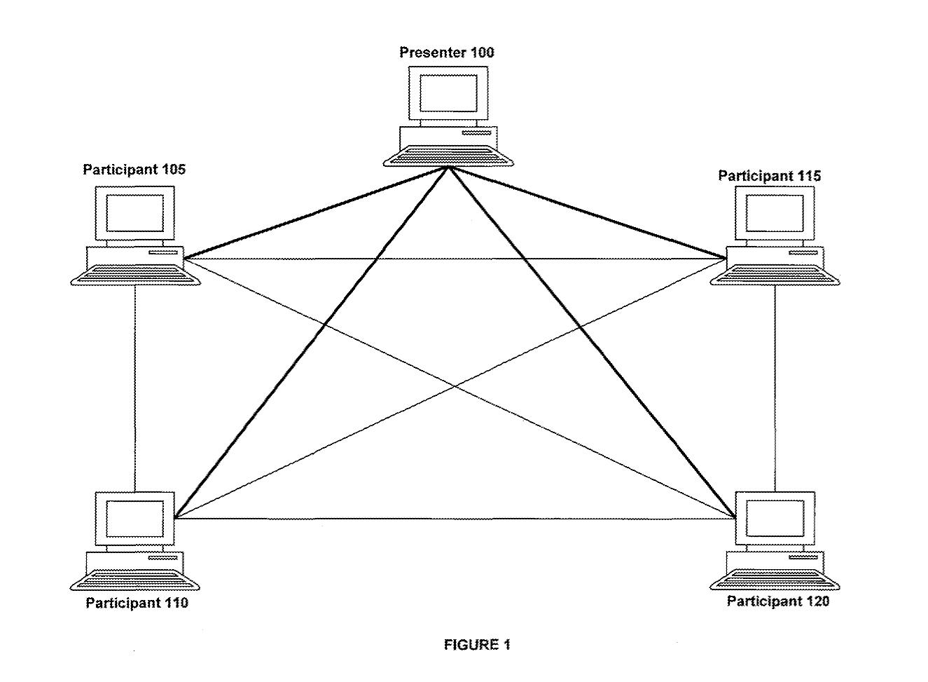

FIG. 1 depicts a peer-to-peer web conferencing topology in which embodiments of the present invention may be utilized. Presenter 100 has established a network connection with each of participants 105, 110, 115 and 120 and each of participants 105, 110, 115 and 120 have also established network connections with each other. Each of presenter 100 and participants 105-120 have a peer-to-peer web conferencing client application (hereinafter, also referred to as “client application”) installed on their computer terminals that presents the web conferencing session and locally manages communications with other participants during the web conferencing session.

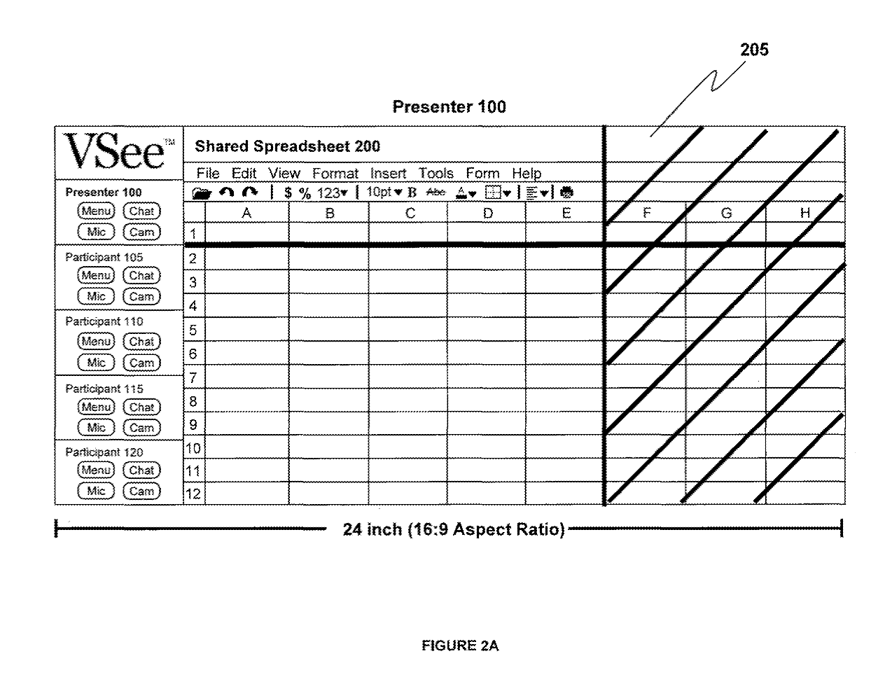

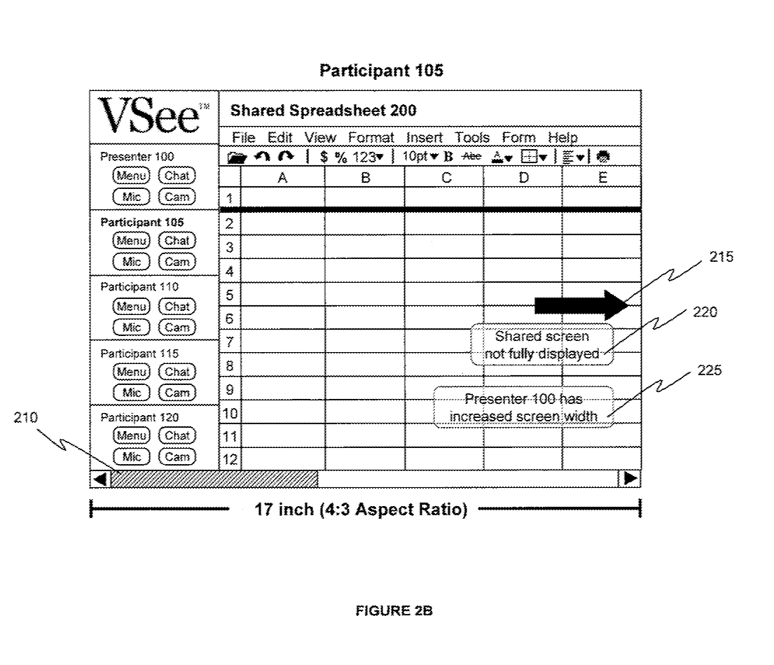

FIGS. 2A-2B depict web conferencing displays of a presenter and a participant during a web conferencing session, according to one embodiment of the present invention. FIG. 2A depicts a web conferencing display as viewed by presenter 100 on his own computer terminal. In this example, the presenter is discussing the contents of a spreadsheet 200 during the web conferencing session and the display of the terminal of presenter 100 is a 24 inch display having a 16:9 aspect ratio. The web conferencing client application on the terminal of presenter 100 has received information (e.g., display width, aspect ratio, etc.) from each of the other participants on the web conference and is therefore able to display textured area 205 (i.e., crossed area) to notify presenter 100 that at least one of the participants of the web conferencing session cannot see textured area 205 (in this case, participant 105). It should be recognized that any alternative type of graphical notification other than textured area 205 may be used in other embodiments, including text notifications, a faded area and the like.

FIG. 2B depicts a web conferencing display as viewed by participant 105 on his computer display, a 17 inch display having a 4:3 aspect ratio. Similar to FIG. 2A, the client application on the terminal of participant 105 has received information relating to the display capabilities of each of the other participants, including presenter 100. Because the display of participant 105 has inferior capabilities to the display of presenter 100, the client application on the terminal of participant 105 displays scroll bar 210, block arrow 215 and text notification 220 in order to notify participant 105 that the display of presenter 100 is wider than the display of participant 105. Additional notifications such as text notification 225 may also be displayed by the web conferencing client application on the terminal of participant 105 if presenter 100 widens the window of application 200 during the web conferencing session. It should be recognized that any alternative type of graphical notification other than scroll bar 210, block arrow 215, and text notifications 220 and 225 may be used in other embodiments.

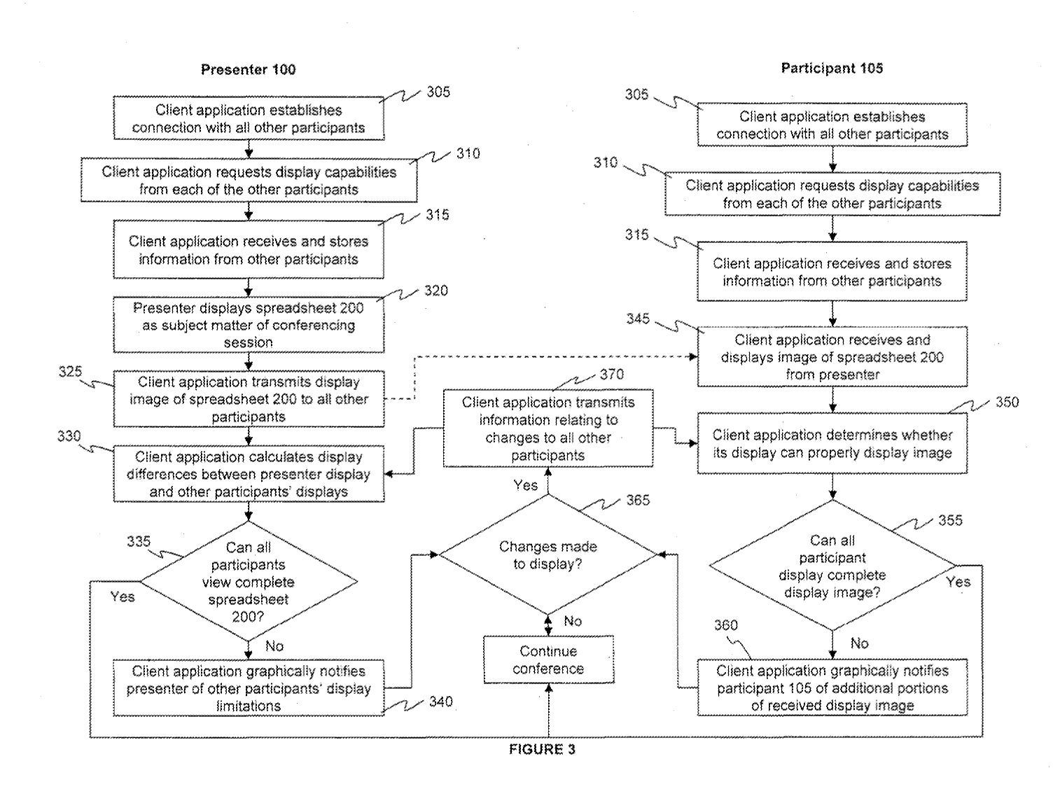

FIG. 3 is a flow diagram of steps taken between a presenter and a participant in a peer-to-peer web conferencing session to notify each other of graphical user interface differences, according to one embodiment of the present invention. Although the method steps are described in conjunction with the spreadsheet depicted in FIGS. 2A-2B, persons skilled in the art will understand that any web conferencing session relating to any subject matter (i.e., not just spreadsheets) falls within the scope of the present invention.

In step 305, the client applications of each of presenter 100 and participant 105 establishes a direct connection to each of the other participants of the web conferencing session. In step 310, the client applications of each of the presenter 100 and participant 105 request information relating to display capabilities (e.g., screen size, resolution, aspect ratio, color capabilities, etc.) from each of the other participants. Upon receipt of such a request, a client application of a participant interacts with its operating system and relevant device drivers to obtain the information and transmits such information back to the requesting client application. In step 315, each of the client applications of presenter 100 and the participant 105 receives and stores the information from the other participants. In step 320, presenter 100 displays spreadsheet 200 as the subject matter of the web conferencing session and the client application of presenter 100 transmits an image of the display to the other participants, including participant 105 in step 325. In step 330, the client application of presenter 100 determines differences in display capabilities between the display of presenter 100 and the displays of the other participants. In step 335, if the client application of presenter 100 determines that certain of the other participants cannot view the complete display of spreadsheet 200, then in step 340, the client application graphically notifies presenter 100 of the limitations of the display capabilities of other participants. In one embodiment, the client application of presenter 100 utilizes a graphical notification similar to textured area 205 of FIG. 2A to indicate the greatest display area that is not visible to one of the participants.

In step 345, the client application of participant 105 receives the display image from presenter 100 and presents the display image for viewing by participant 105. In step 350, the client application of participant 105 determines whether its display has the capability to properly display the received display image. In step 355, if the client application determines that the display image cannot be completely displayed, it graphically notifies participant 105 of its display limitations in step 360. In one embodiment, the client application of participant 105 utilizes a graphical notification similar to the various graphical notifications of FIG. 2B.

In step 365, if during the web conferencing session, either of presenter 100 or participant 105 change the characteristics of his display (e.g., window size for spreadsheet 200, display resolution, etc.), then in step 370, the respective client application recognizes the changes in display capability or displayed image and transmits the information relating to the changes to all the other participants, enabling the displays of such participants to be dynamically updated with graphical notifications by their corresponding client applications, to the extent needed. It should be recognized that in alternative embodiments, participants in a web conference session may only communicate with the presenter rather than with all the other participants. In such an embodiment, for example, participant 105 may only request and obtain display capability information from presenter 100 in steps 310 and 315 and may only transmit changes relating to its own display to the presenter rather than all of the other participants in step 370. Similarly, in yet other embodiments, display information of presenter 100 may be embedded in the display images transmitted in step 320 such that participant 105 need not request such information from presenter 100 in step 310.

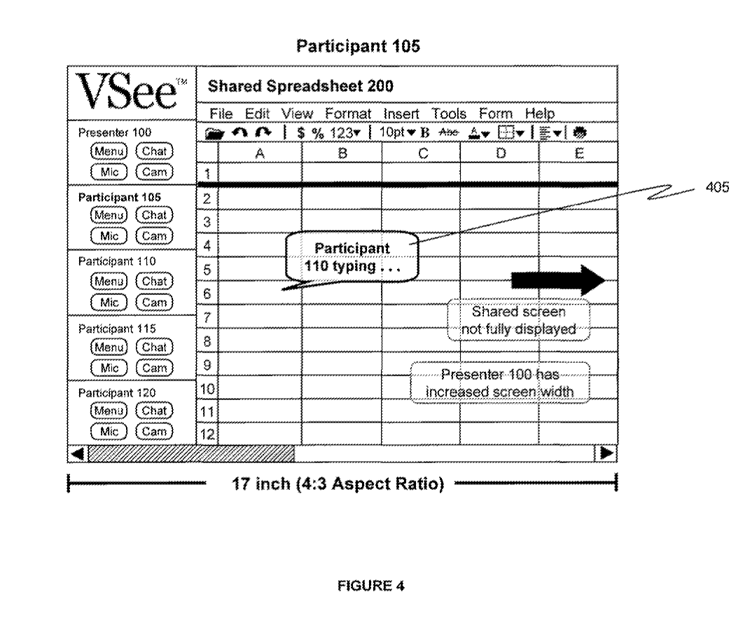

As shown by FIG. 1, a peer-to-peer web conferencing system enables client applications to receive and calculate display differences locally such that other participants do not suffer from a lowest common denominator approach of a central server if such participants are capable of fully displaying the presenter's display image. However, as previously discussed, the lack of a central server in a peer-to-peer web conferencing system means that there is no central entity that controls the pace of a conference and notifies each of the participants, for example, if a participant with a significantly lower bandwidth connection is interacting with display of the web conference. Without a central management function, collaboration can create confusion, if, for example, the participant with the slow bandwidth connection is interacting with a display that is no longer current. FIG. 4 displays one example of a graphical notification displayed by a client application of a peer-to-peer web conferencing system if a participant is interacting with the display of the web conference. Callout 405 notifies participant 105 that participant 110 is currently editing spreadsheet 200 so that participant 105 can wait until participant 110 completes the editing prior to interacting with spreadsheet 200 itself. It should be recognized that various other graphical notifications can be used other than callout 405 of FIG. 4, including progress bars and other similar indicators.

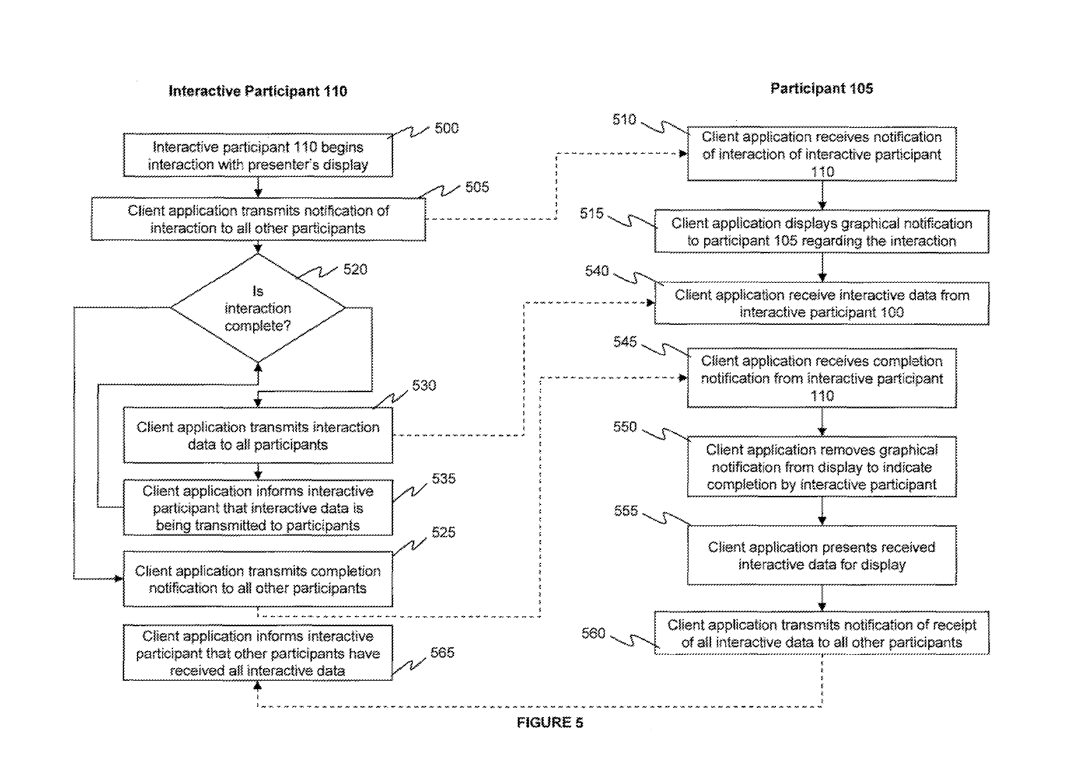

FIG. 5 is a flow diagram of steps taken by a participant in a peer-to-peer web conferencing session interacting with a presenter's display, according to one embodiment of the present invention. In step 500, interactive participant 110 begins to interact with the presenter's display, for example, by typing into a cell of spreadsheet 200, using painting tools offered by its client application or all possible other interactions depending upon the subject matter of the presenter's display (e.g., zooming in on a complex photographic display by presenter 100 resulting significant transmission of photographic data across the network, etc.) and the I/O device (e.g., keyboard, mouse, touch screen, etc.). In step 505, the client application of interactive participant 110 notifies each of the other participants, including participant 105, that interactive participant 110 has begun to interact with the display of presenter 100. In step 510, client application of participant 105 (and all other participants) receives the notification of step 505 and in step 515, displays a graphical notification to participant 105 that interactive participant 110 is interacting with the presented display. One embodiment of such a graphical notification is the callout of FIG. 4. In step 520, if interactive participant 110 completes the interaction, then in step 525, the client application of interactive participant 110 transmits a completion notification to each of the other participants, including participant 105. If, in step 520, interactive participant 110 continues interacting with the display, then in step 530, the client application of interactive participant continues to transmit the data relating to the interaction (e.g., text, whiteboard actions, photographic data, etc.) to all the participants. In step 535, the client application of the interactive participant 110 provides a graphical notification to interactive participant 110 that data relating to the interaction is being transmitted to all the other participants. In one embodiment, such graphical notification is a progress bar, text, or other similar notification. In step 540, the client application of participant 105 receives and stores the interaction data from step 530. In step 545, the client application of participant 105 receives the completion notification from step 525 and in step 550, it removes the displayed graphical notification to indicate that interactive participant 110 is done. In step 555, the client application of participant 105 also presents the completely received data from the interaction received in step 540 for display to participant 105 and in step 560, the client application of participant 105 transmits a notification to all other participants that is has successfully received all the data relating from the interaction from interactive participant 110. In step 565, the client application of interactive participant 110 receive such notification and when it receives the similar notifications from all other participants, notifies interactive participant 110 that all other participants has successfully received the data from the interaction (e.g., by removing the graphical notification of step 535 or presenting another graphical notification). It should be recognized that alternative embodiments may not execute all the steps of FIG. 5. For example, participant 105 may only transmit the notification of 560 to interactive participant 110 rather than all participants. Similar, alternative embodiments may not implement the transmission of completion notifications (or indication of transmission progress or reception progress) from interactive participant 110 or from other participants such as participant 105. Furthermore, alternative embodiment may, for example, prevent a participant 105 from interacting with his own local display until the client application receives the completion notification in step 545.

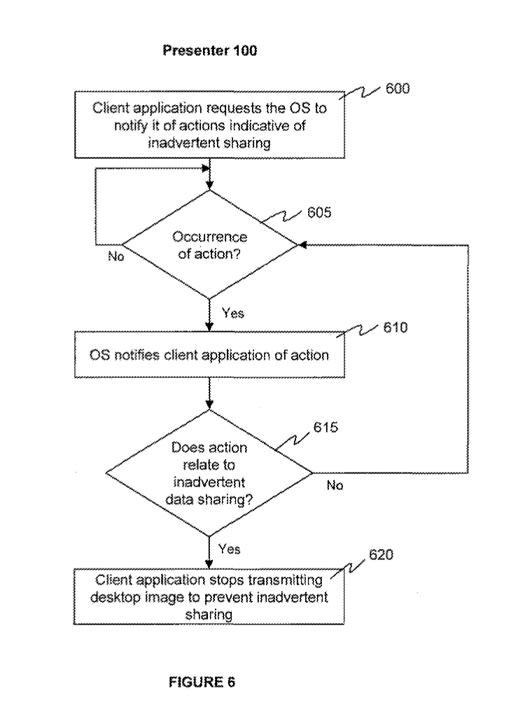

A peer-to-peer web conferencing system in accordance with one embodiment of the present invention may further incorporate graphical user security features for a presenter. FIG. 6 is a flow diagram of steps taken by a client application of a presenter in a peer-to-peer web conferencing session to prevent inadvertent sharing of information, according to one embodiment of the present invention. In step 600, the client application of the presenter requests that the operating system of the presenter's terminal notify the client application of actions indicative of inadvertent sharing during a web conferencing session. Such actions may include, for example, a user selecting (via a mouse) a different window relating to an application other than the currently shared application or an automatic pop-up message from a non-displayed application. In one embodiment, for example, the client application registers callbacks with the operating system to be notified of window events. In step 605, if an action occurs (e.g., mouse event, pop-up window, etc.), then, in step 610, the operating system notifies the client application of the action. In step 615, the client application determines whether the action relating to the notification relates to a possible inadvertent sharing of information during the web conferencing, such as, for example, a user selection that launches a new application such as a personal email application or a pop-up message from an instant messaging application running in the background. In step 620, if the action relates to a possible inadvertent sharing of information, the client application stops transmitting desktop image information of the presenter to prevent such inadvertent sharing. Additionally, or alternatively, the client application may also display a warning to the presenter prior to allowing execution of the action.

The invention has been described above with reference to specific embodiments. Persons skilled in the art, however, will understand that various modifications and changes may be made thereto without departing from the broader spirit and scope of the invention as set forth in the appended claims. For example, while the foregoing description has discussed peer-to-peer web conferencing in its embodiments, it should be recognized that any type of peer-to-peer collaborative conferencing, including teleconference, audio conferencing, online chatting and the like can implement techniques disclosed herein. The foregoing description and drawings are, accordingly, to be regarded in an illustrative rather than a restrictive sense. Terminology used in the foregoing description is for the purpose of describing the particular versions or embodiments only, and is not intended to limit the scope of the present invention which will be limited only by the appended claims. As used herein and in the appended claims, the singular forms “a,” “an,” and “the” include plural references unless the context clearly dictates otherwise. Similarly, the words “for example”, “such as”, “include,” “includes” and “including” when used herein shall be deemed in each case to be followed by the words “without limitation.” Unless defined otherwise herein, all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

We claim:

1. A method for preventing inadvertent sharing of a local display in a peer-to-peer conferencing session among a plurality of participant computer systems, the method comprising the steps of:
establishing a direct network connection with each of the participant computer systems;
requesting from an operating system of the local computer system notification of actions indicative of inadvertent sharing on the local display;
receiving a notification of an action indicative of inadvertent sharing from the operating system; and
halting transmission of display image data to the participant computer systems.

2. The method of claim 1, further comprising the step of displaying a warning prior to executing the action.

3. The method of claim 1, wherein the action is a selection of a new window on the local display.

4. The method of claim 1, wherein the action is a pop-up message on the local display from a non-displayed application.

5. A computer readable storage medium having stored therein a computer program for providing display notifications in a peer-to-peer conferencing session among a plurality of participant computer systems, wherein a computer system executing the computer program carries out the steps of:
establishing a direct network connection with each of the participant computer systems;
receiving information relating to display capabilities of each of the participant computer systems through each established direct network connection;
determining a difference in capabilities between the received information and a local display of a local computer system;
presenting a display notification relating to the determined difference on the local display;
requesting from an operating system of the local computer system notification of actions indicative of inadvertent sharing on the local display;
receiving a notification of an action indicative of inadvertent sharing from the operating system; and
halting transmission of display image data to the participant computer systems.

6. The computer-readable medium of claim 5, wherein the processing unit further performs the step of displaying a warning prior to executing the action.
